(19) United States
(12) Patent Application Publication
(10) Pub. No.: US 2025/0381906 A1
(43) Pub. Date: Dec. 18, 2025

(54) Expandable Enclosure System

(71) Applicants: Bradley Scott Meilak, Roanoke, VA (US); Julie Ann Meilak, Roanoke, VA (US)

(72) Inventors: Bradley Scott Meilak, Roanoke, VA (US); Julie Ann Meilak, Roanoke, VA (US)

(21) Appl. No.: 19/231,410

(22) Filed: Jun. 6, 2025

Related U.S. Application Data
(60) Provisional application No. 63/661,458, filed on Jun. 18, 2024.

(51) Int. Cl. B60P 3/34

(52) U.S. Cl. CPC B60P 3/34

(57) ABSTRACT

An expandable enclosure system with rigid panels comprising of an expandable assembly and a base assembly is shown and described. The expandable assembly is closed for transit, protecting windows, fans, vents, doors, or similar located in the rigid panels. When not in transit the expandable assembly is opened to its usable position. The expandable enclosure system when coupled to a platform, such as a truck bed or similar, creates a secure and protected enclosed volume for the storage of desired equipment and goods. The platform can be accessed from the outside through the tailgate or from the interior of the system through hatches and openings in the floor.

### CROSS-REFERENCE TO RELATED APPLICATIONS

This application claims the benefit of U.S. Provisional Application Ser. No. 63/661,458, filed Jun. 18, 2024 and entitled Expandable Enclosure System, the entire contents of which are incorporated herein by reference.

### BACKGROUND OF THE INVENTION

Camping is a popular past time. Ground tents, roof top tents, truck topper tents, and pop-top truck campers offer limited protection from the environment and elements. Traditional hard-sided truck campers are somewhat large and lack aerodynamic efficiency causing high fuel consumption. The benefit of an expandable enclosure system with rigid panels includes better fuel economy, improved indoor comfort, plus protection from external elements and the environment.

### FIELD OF THE INVENTION

The invention generally relates to an expandable enclosure system, typically used as a camping system, that may be coupled on a vehicle, such as a truck bed, truck flat bed, van, or car, a trailer, or other mobile platform, or used as a standalone enclosure.

### SUMMARY OF THE INVENTION

The expandable enclosure system comprises of a base assembly and an expandable assembly with rigid panels. The expandable assembly articulates upwards and outwards to expand the interior volume when the expandable enclosure system is not in transit. The expandable assembly is in a closed position during transit. This decreases the height of the expandable enclosure system and protects elements, such as windows, contained within the panels of the expandable assembly.

The expandable enclosure system is comprised of a floor, which when coupled to another platform, such as a truck bed, allows for the expandable enclosure system and the enclosed volume of the other platform, such as the truck bed, to be used independently of each other. This increases the flexibility of use and amount of storage space.

### BRIEF DESCRIPTION OF THE DRAWINGS

The following figures are illustrative of the preferred method and use and are not meant to limit the scope of the invention.

FIGS. 1A-1F are orthogonal views showing an embodiment of the expandable enclosure system coupled to a truck bed.

FIG. 1A is an orthogonal view showing the embodiment of the expandable enclosure system in a closed position with the tailgate of the truck in a closed position.

FIG. 1B is an orthogonal view showing the embodiment of the expandable enclosure system in a closed position with the tailgate of the truck in an open position.

FIG. 1C is an orthogonal view showing the embodiment of the expandable enclosure system in an intermediate position with the tailgate of the truck in a closed position.

FIG. 1D is an orthogonal view showing the embodiment of the expandable enclosure system in an open position with the tailgate of the truck in a closed position.

FIG. 1E is an orthogonal view showing the embodiment of the expandable enclosure system in an open position with the tailgate of the truck in a closed position. An open entry hatch and an entry aiding device are also shown.

FIG. 1F is an orthogonal view showing the embodiment of the expandable enclosure system in an open position with the tailgate of the truck in an open position. An open entry hatch and an entry aiding device are also shown.

FIGS. 2A-2D are top views of the embodiment of the expandable enclosure system shown in FIGS. 1A-1F without the roof depicted.

FIG. 2A is a top view of the embodiment of the expandable enclosure system shown in FIGS. 1A-1F without the roof or rear panel depicted, showing the upper and lower panels in a closed position.

FIG. 2B is a top view of the embodiment of the expandable enclosure system shown in FIGS. 1A-1F without the roof depicted, showing the upper, lower, and rear panels in a closed position.

FIG. 2C is a top view of the embodiment of the expandable enclosure system shown in FIGS. 1A-1F without the roof depicted, showing the upper, lower, and rear panels in an intermediate position.

FIG. 2D is a top view of the embodiment of the expandable enclosure system shown in FIGS. 1A-1F without the roof depicted, showing the upper, lower, and rear panels in an open position.

FIGS. 3A-3F are sectional views of the embodiment of the expandable enclosure system shown in FIGS. 1A-1F.

FIG. 3A is a sectional view of the embodiment of the expandable enclosure system shown in FIGS. 1A-1F in a closed position with the tailgate of the truck in a closed position.

FIG. 3B is a sectional view of the embodiment of the expandable enclosure system shown in FIGS. 1A-1F in a closed position with the tailgate of the truck in an open position.

FIG. 3C is a sectional view of the embodiment of the expandable enclosure system shown in FIGS. 1A-1F in an intermediate position with the tailgate of the truck in a closed position.

FIG. 3D is a sectional view of the embodiment of the expandable enclosure system shown in FIGS. 1A-1F in an open position with the tailgate of the truck in a closed position.

FIG. 3E is a sectional view of the embodiment of the expandable enclosure system shown in FIGS. 1A-1F in an open position with the tailgate of the truck in a closed position. An open entry hatch and an entry aiding device are also shown.

FIG. 3F is a sectional view of the embodiment of the expandable enclosure system shown in FIGS. 1A-1F in an open position with the tailgate of the truck in an open position. An open entry hatch and an entry aiding device are also shown.

FIGS. 4A-4F are side views of the embodiment of the expandable enclosure system shown in FIGS. 1A-1F.

FIG. 4A is a side view of the embodiment of the expandable enclosure system shown in FIGS. 1A-1F in a closed position with the tailgate of the truck in a closed position.

FIG. 4B is a side view of the embodiment of the expandable enclosure system shown in FIGS. 1A-1F in a closed position with the tailgate of the truck in an open position.

FIG. 4C is a side view of the embodiment of the expandable enclosure system shown in FIGS. 1A-1F in an intermediate position with the tailgate of the truck in a closed position.

FIG. 4D is a side view of the embodiment of the expandable enclosure system shown in FIGS. 1A-1F in an open position with the tailgate of the truck in a closed position.

FIG. 4E is a side view of the embodiment of the expandable enclosure system shown in FIGS. 1A-1F in an open position with the tailgate of the truck in a closed position. An open entry hatch and an entry aiding device are also shown.

FIG. 4F is a side view of the embodiment of the expandable enclosure system shown in FIGS. 1A-1F in an open position with the tailgate of the truck in an open position. An open entry hatch and an entry aiding device are also shown.

FIGS. 5A-C are cross sectional views of the embodiment of the expandable enclosure system shown in FIGS. 1A-1F without the roof and the platform depicted.

FIG. 5A is a cross sectional view of the embodiment of the expandable enclosure system shown in FIGS. 1A-1F without the roof and the platform depicted, showing the upper, lower, and rear panels in a closed position.

FIG. 5B is a cross sectional view of the embodiment of the expandable enclosure system shown in FIGS. 1A-1F without the roof and the platform depicted, showing the upper, lower, and rear panels in an intermediate position.

FIG. 5C is a cross sectional view of the embodiment of the expandable enclosure system shown in FIGS. 1A-1F without the roof and the platform depicted, showing the upper, lower, and rear panels in an open position.

FIG. 6 is a bottom view of the embodiment of the expandable enclosure system shown in FIGS. 1A-1F.

FIGS. 7A-7C are orthogonal views showing an alternative embodiment of the expandable enclosure system coupled to an alternative platform.

FIG. 7A is an orthogonal view showing an alternative embodiment of the expandable enclosure system in a closed position.

FIG. 7B is an orthogonal view showing an alternative embodiment of the expandable enclosure system in an intermediate position.

FIG. 7C is an orthogonal view showing an alternative embodiment of the expandable enclosure system in an open position.

FIG. 8 is a flowchart of the preferred method and use of the expandable enclosure system shown in FIGS. 1A-1F.

### DETAILED DESCRIPTION OF THE INVENTION

The following is a description of an embodiment of the preferred method and use of the expandable enclosure system and is not meant to limit the scope of the invention.

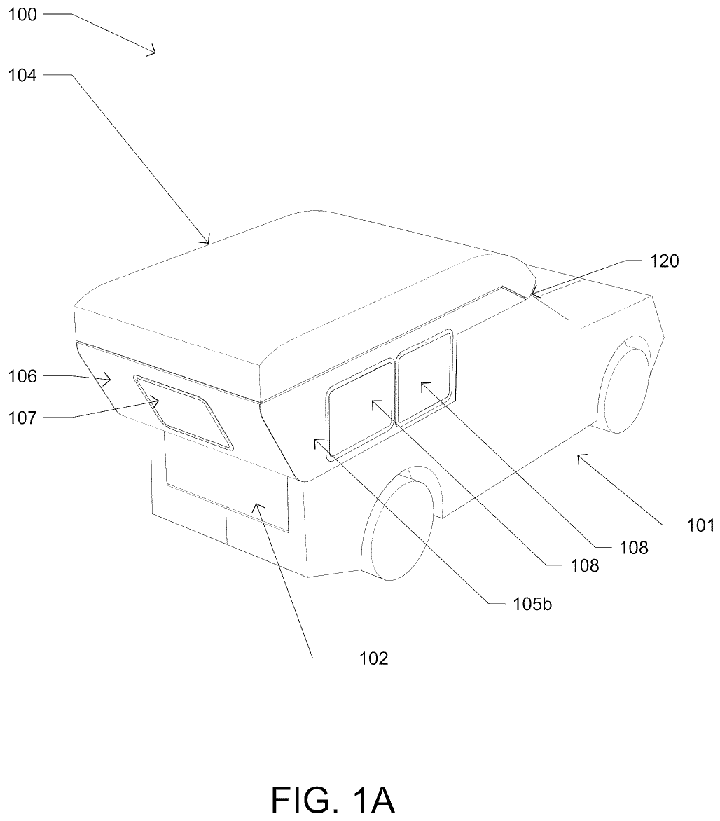

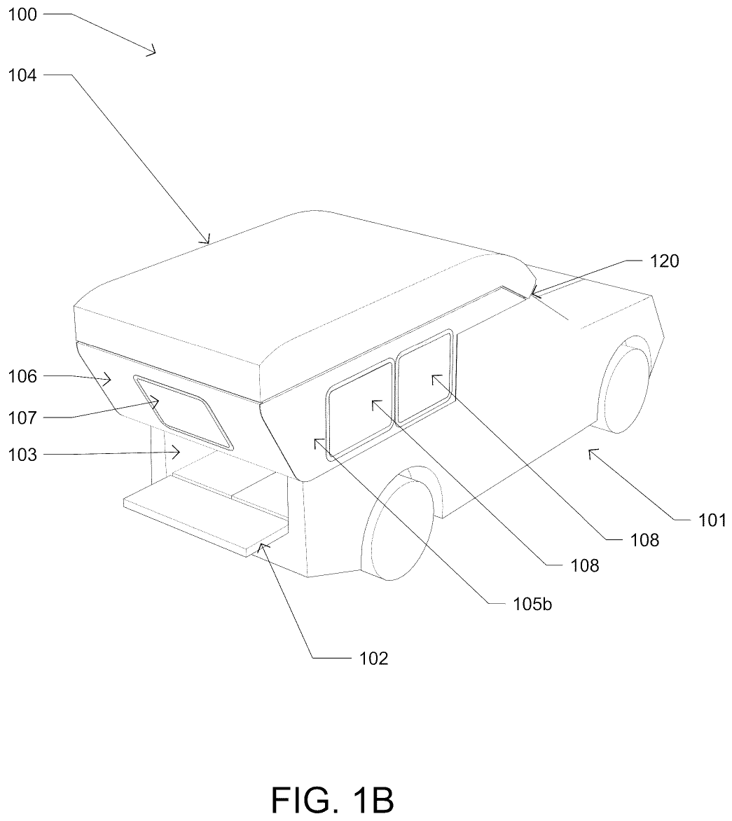

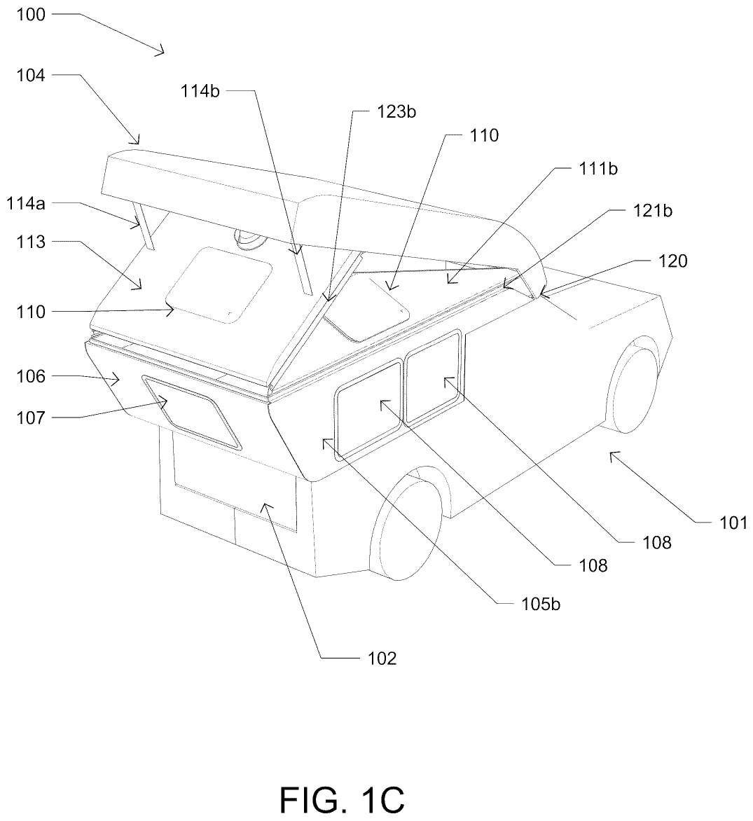

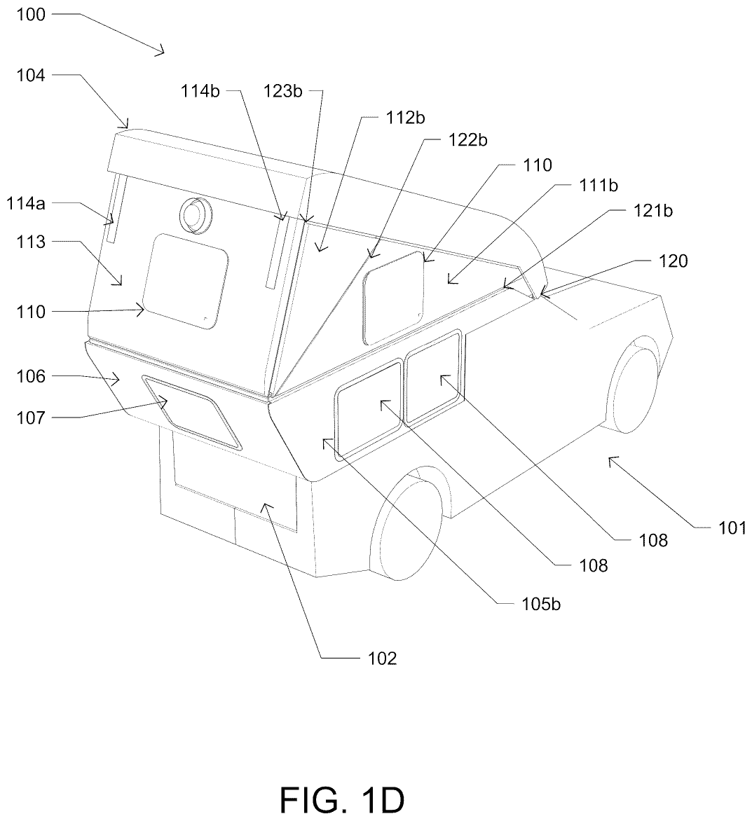

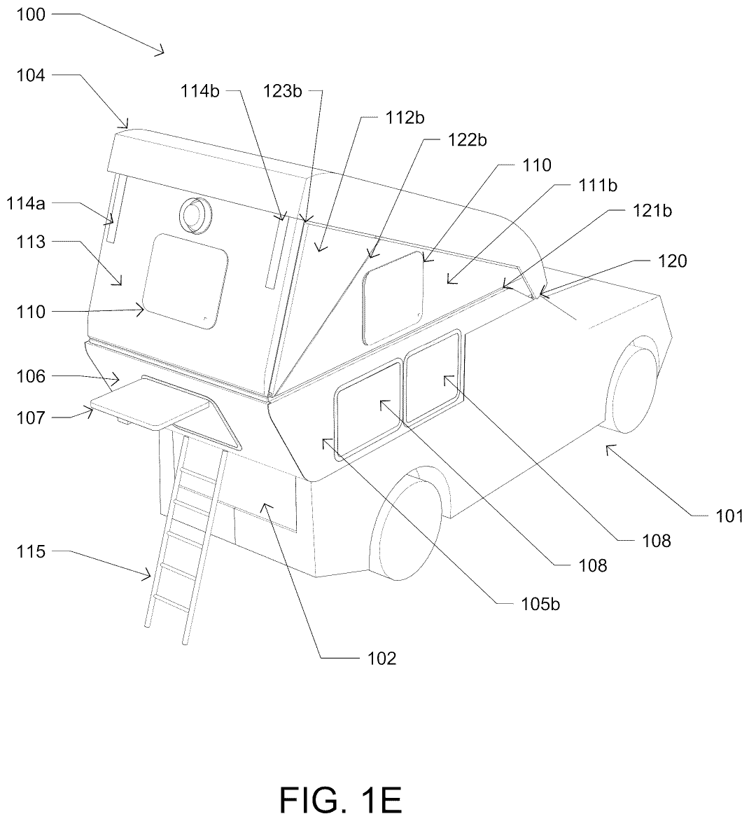

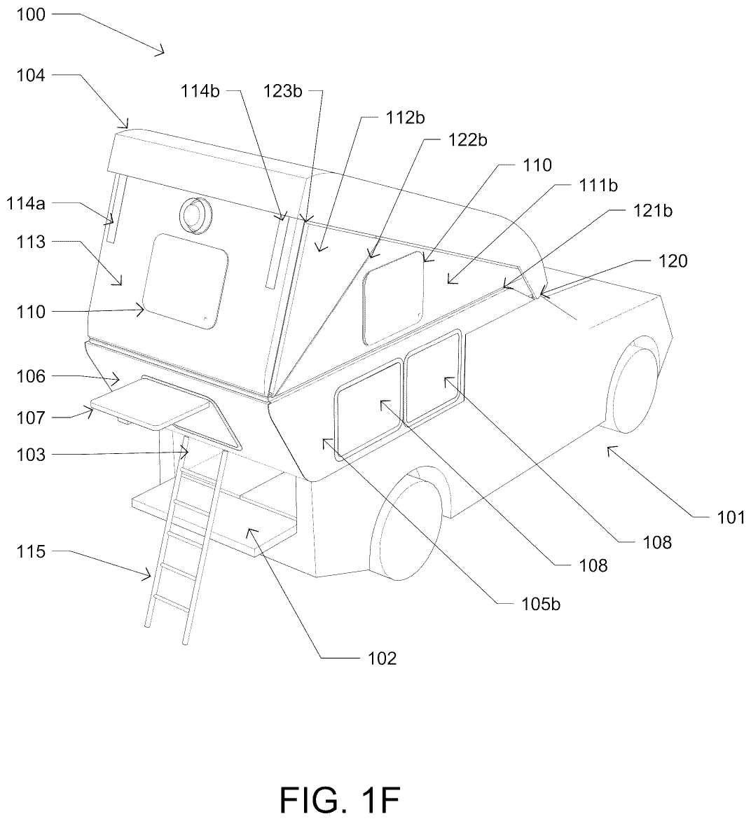

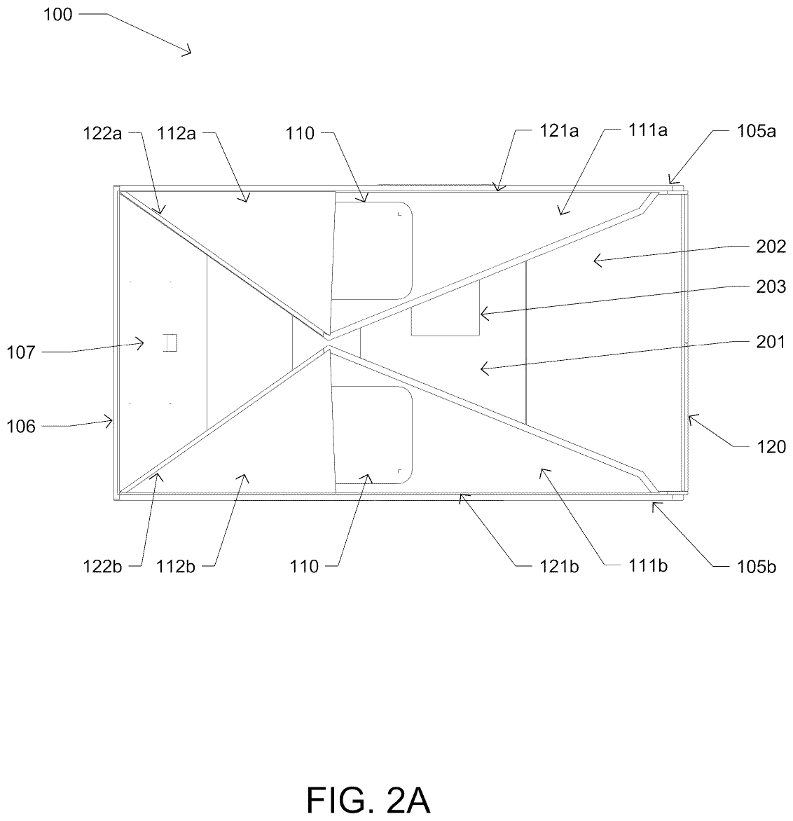

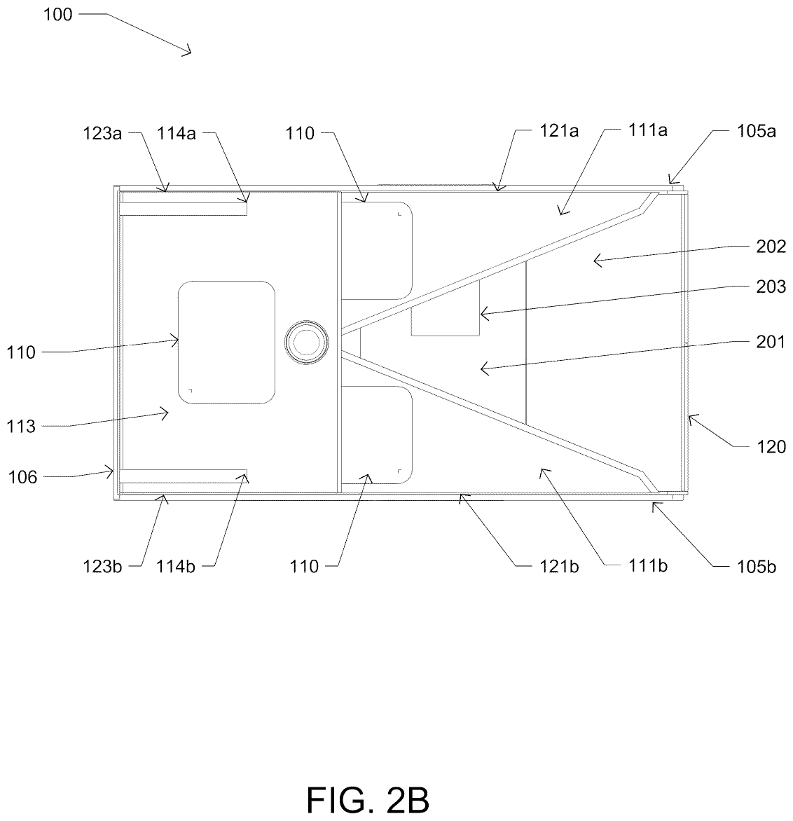

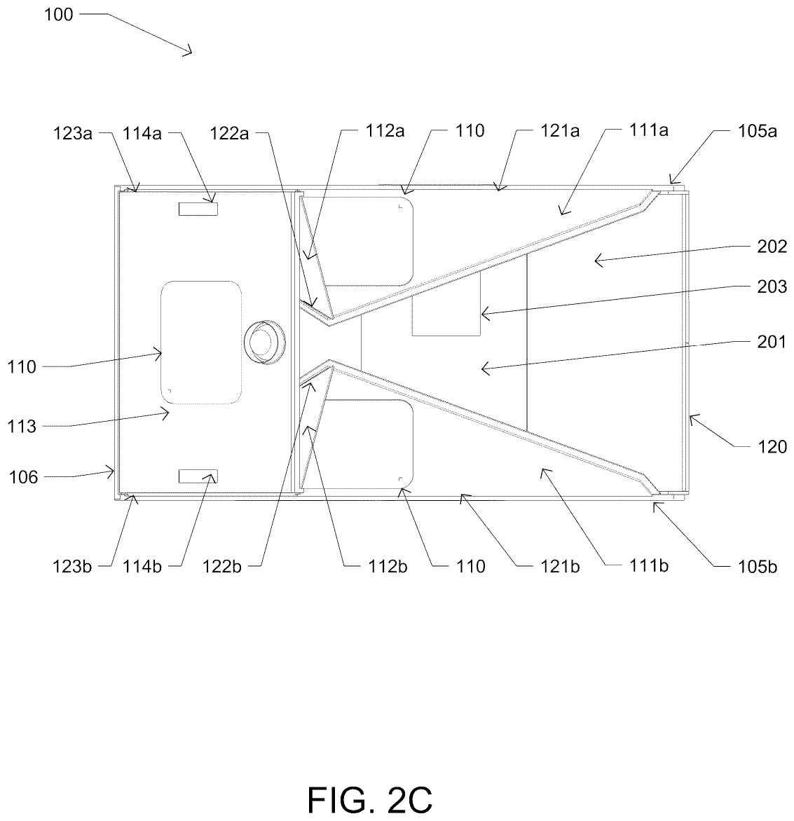

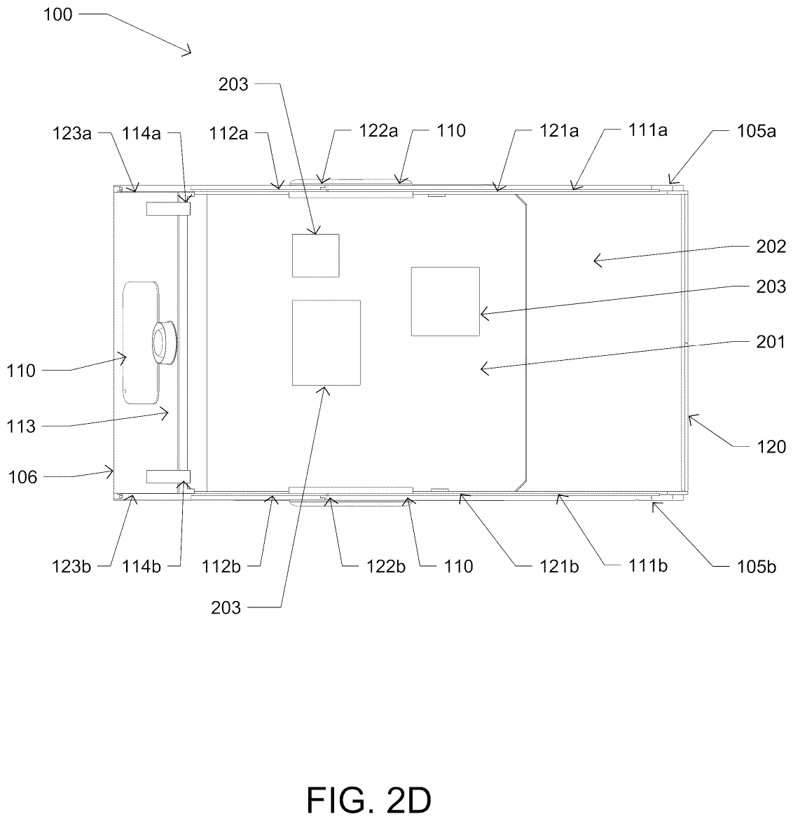

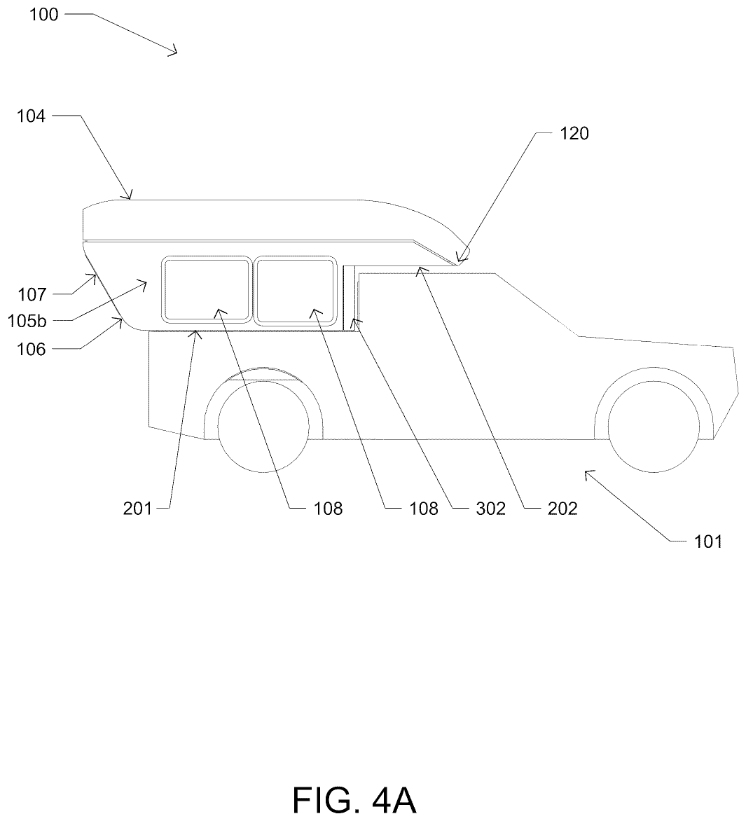

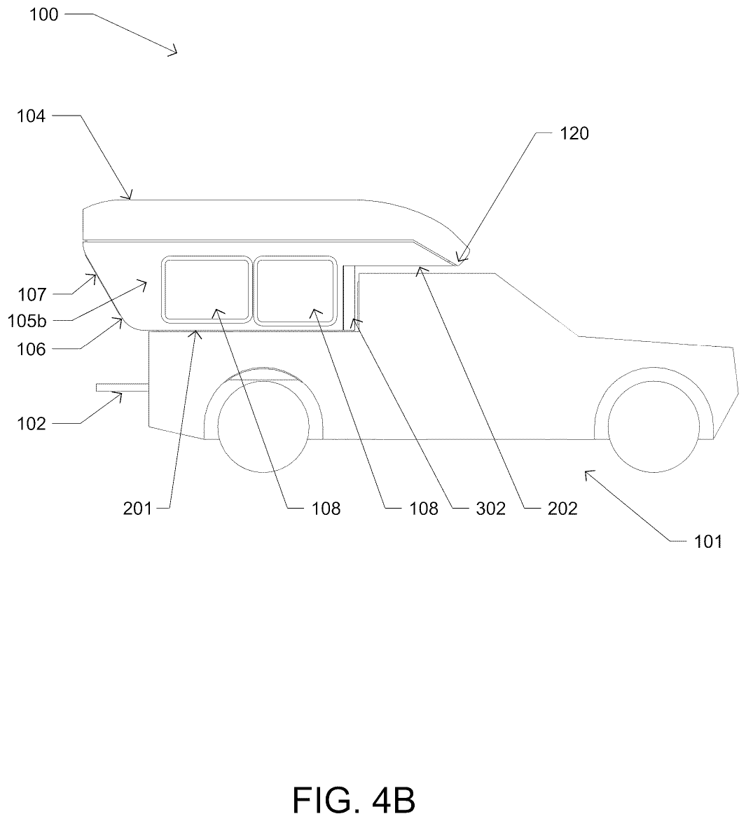

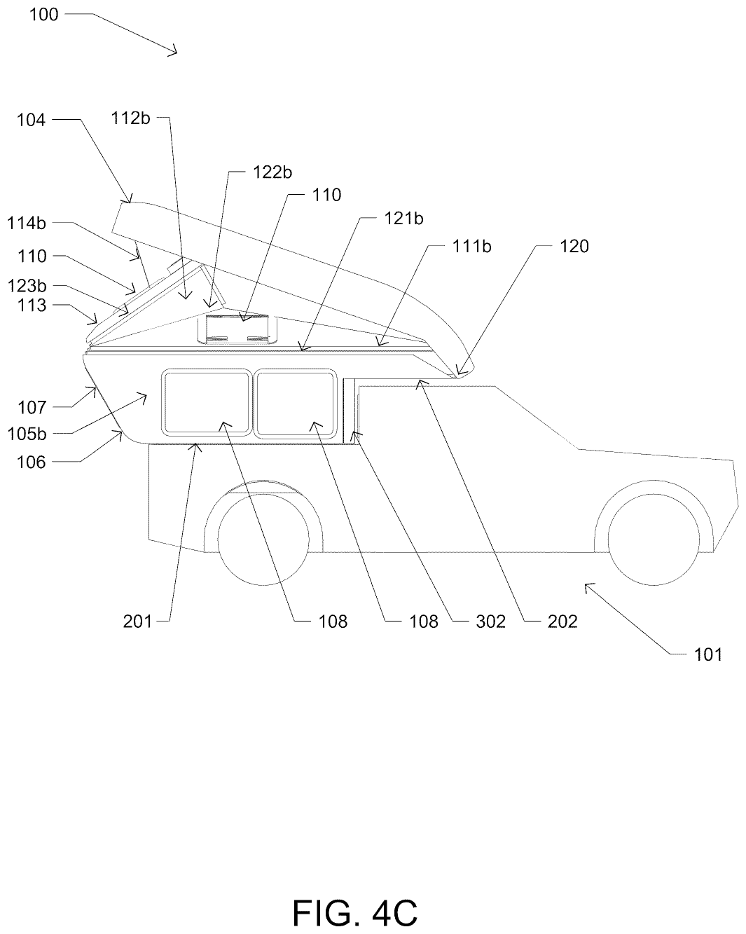

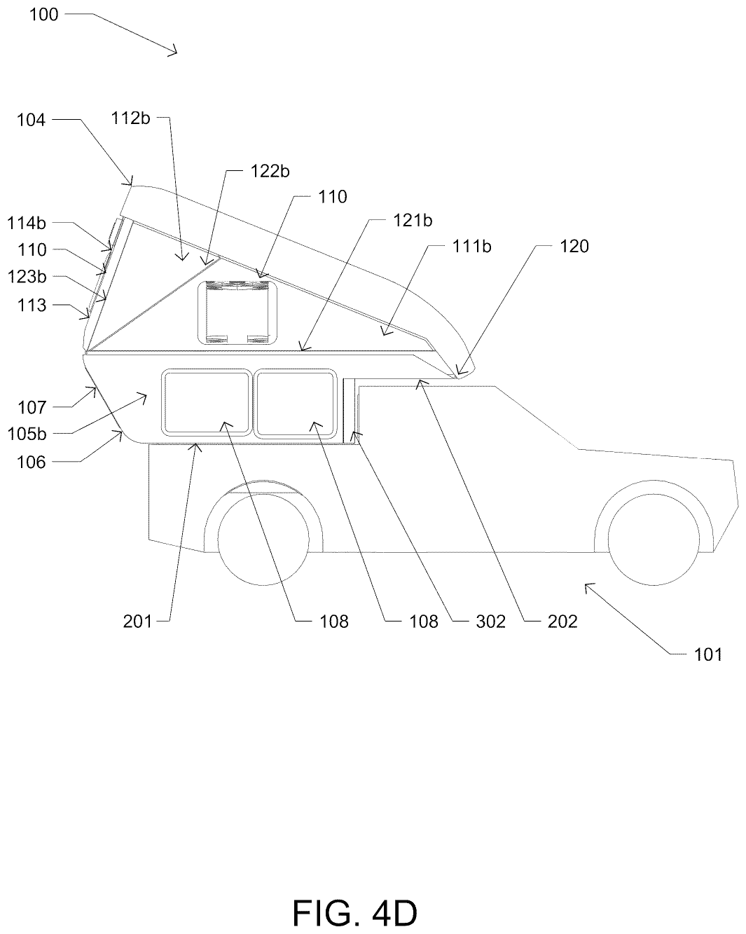

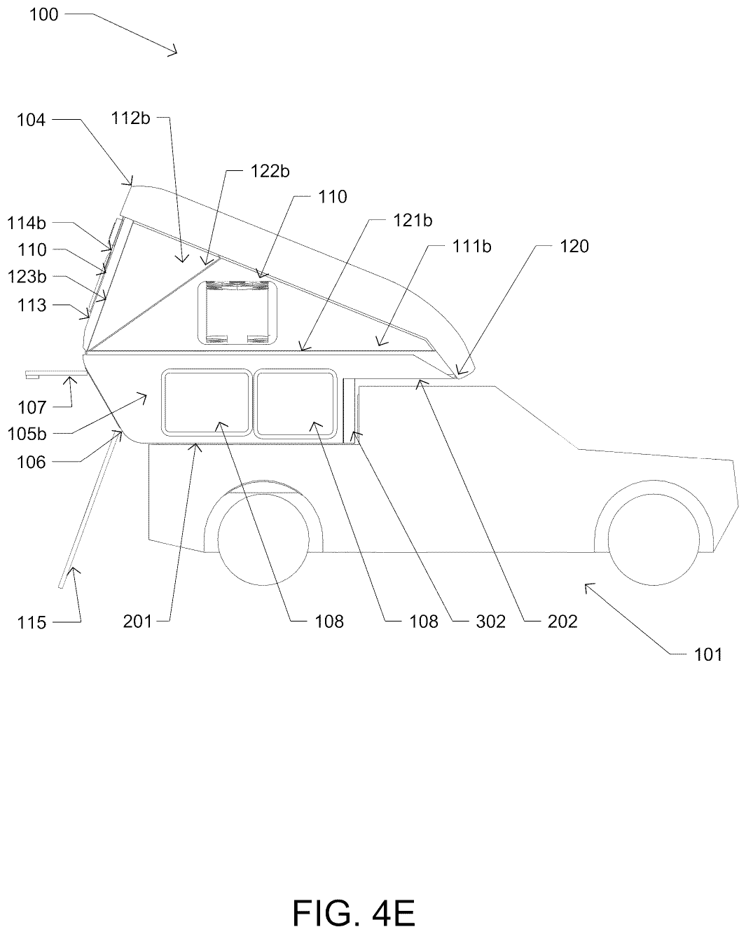

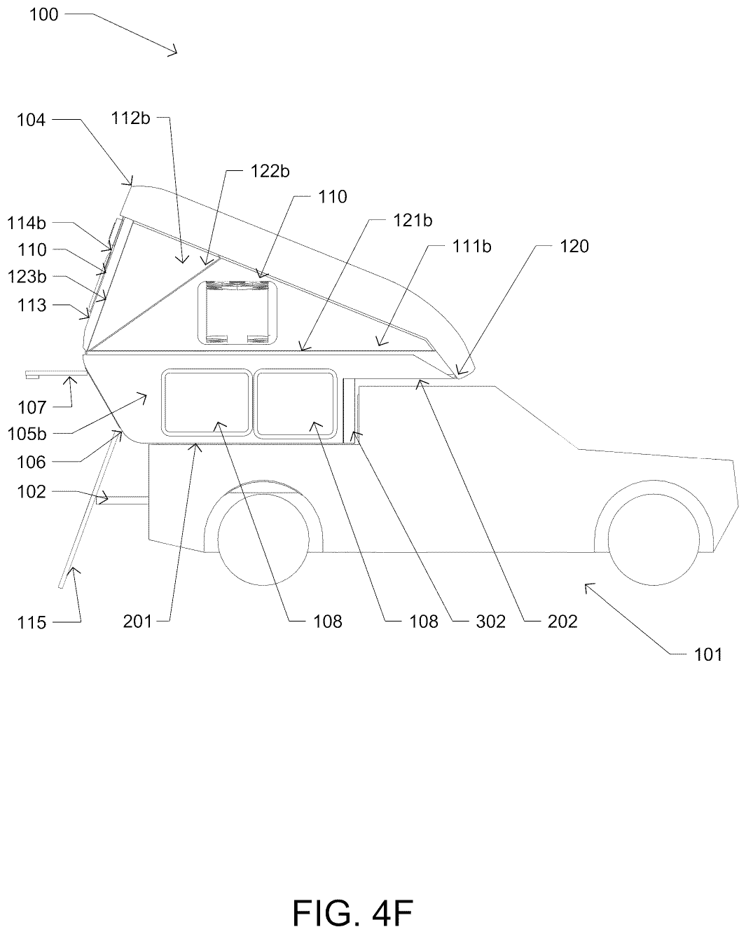

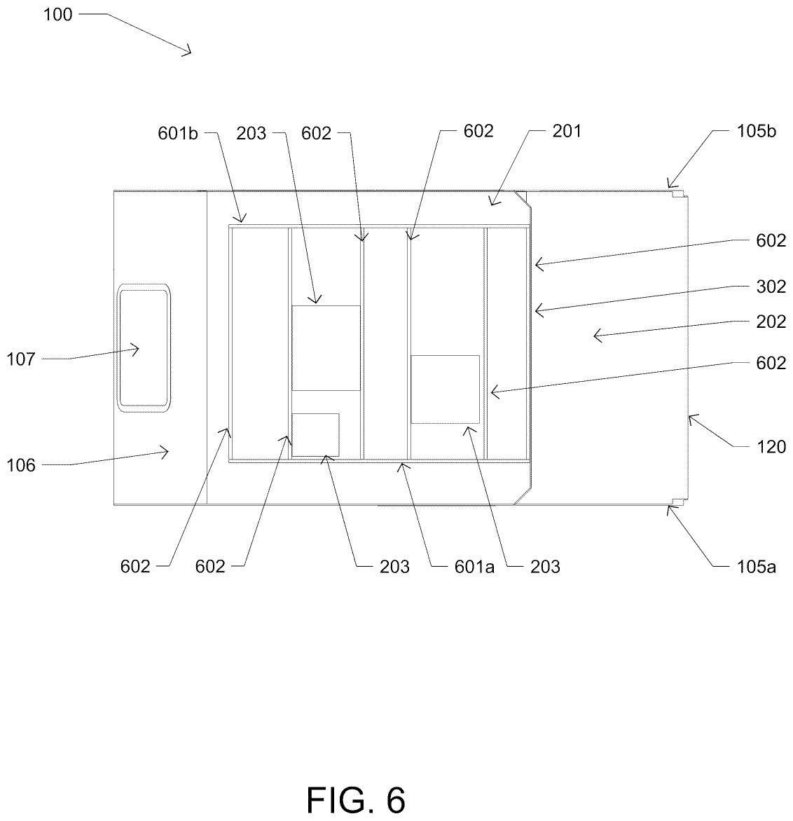

Reference is made to the elements depicted in the FIGS. 1-8 listed above.

Examples of the benefits of the expandable enclosure system 100 include as a habitat for outdoor activities, such as camping, hunting, fishing, mountain biking, rock climbing, kayaking, hiking, skiing and snowboarding, surfing, or other similar activities. Other uses include, but are not limited to, full-time living or emergency response use.

In the depicted embodiment, the system 100 is coupled to a platform 101, such as a truck bed, truck flat bed, van, car, trailer, boat or other mobile platform, or used as a standalone enclosure. This is achieved by the use of the subframe 301 or other mechanism, such as legs. Other methods may be used in other embodiments.

The subframe 301 when used will be specific to the individual platform. The subframe 301, which is coupled to the system 100, allows for the system 100 to be securely coupled to the platform 101 to provide safe transit and use. In the depicted embodiment, the subframe 301 is built to allow the system 100 to be coupled to the top of the platform 101 and comprises of frame rails 601a and 601b and cross members 602. In other embodiments, the subframe 301 can be modified to account for different widths and lengths of various platforms, such as a truck bed, truck flat bed, trailer, SUV, sedan, van, boat, or similar. The number and placement of the cross members can also vary in other embodiments. The subframe 301 can be made of a material such as aluminum, steel, wood, composite, or similar.

All walls, panels, floor, and roof in this embodiment are made of a rigid material, such as a composite panel. A rigid material provides more protection from outside elements, such wind, rain, snow, heat, cold, and animals, when compared to a non-rigid material. Other rigid materials may be used in other embodiments.

In the depicted embodiment, the system 100 includes both a base assembly and an expandable assembly. The base assembly comprises of two side walls 105a and 105b, a front wall 302, a rear wall 106, a floor 201, and a cabover 202. The expandable assembly of the system 100 comprises of a roof 104, a rear panel 113, and two sides, each comprising of a lower side panel 111a and 111b and an upper side panel 112a and 112b.

In other embodiments, the size of the expandable enclosure system 100, including the location of front wall 302, the size or deletion of the cabover 202, may be adjusted to accommodate various platforms 101, such as various truck beds, truck flat bed, trailer, SUV, sedan, van, boat, or similar. Other embodiments of the system 100 can be utilized.

In the depicted embodiment, the two side walls 105a and 105b contain hatches 108, which allow access to the interior volume regardless of whether the system 100 is open or closed. Other elements can also be included in other embodiments, such as fans, vents, windows, doors, or similar. This list is not exhaustive and is only meant to show examples of other elements that can be included. The size and number of hatches 108 or other elements can vary in other embodiments. This includes the inclusion or deletion of hatches, doors, windows, or similar, in the front wall 302 and rear wall 106.

In the depicted embodiment, the rear wall 106 includes a hatch 107 large enough to allow a person to enter the system 100. The rear wall 106 is also at an angle to aid entry into the system 100. The angle of the rear wall 106 may be changed in other embodiments. Entry into the system 100 may also be aided by a device 115, such as a ladder, step, or similar.

In the depicted embodiment, the floor 201 separates the system 100 from the platform 101 to which it is coupled. This allows the system 100 and the platform 101 to be used independently of each other. This is shown in the figures by the tailgate 102 being open in some figures and closed in other figures, allowing the enclosed volume of the platform 103 to be accessed regardless of whether the system 100 is open or closed. In the depicted embodiment, the floor 201 contains hatches 203, which allows access to the enclosed volume of the platform 103 from within the system 100. The size and number of hatches, openings, or similar, can vary in other embodiments.

In the depicted embodiment, the roof 104 comprises of a top, two sides, a front, and a rear, all of which encapsulate the side panels 111a, 111b, 112a, 112b and rear panel 113 of the system 100 when in the closed position. In the depicted embodiment, the rear panel 113 is rectangular in shape and the side panels 111a, 111b, 112a, 112b are triangular in shape. Other shapes and configurations may be used in other embodiments.

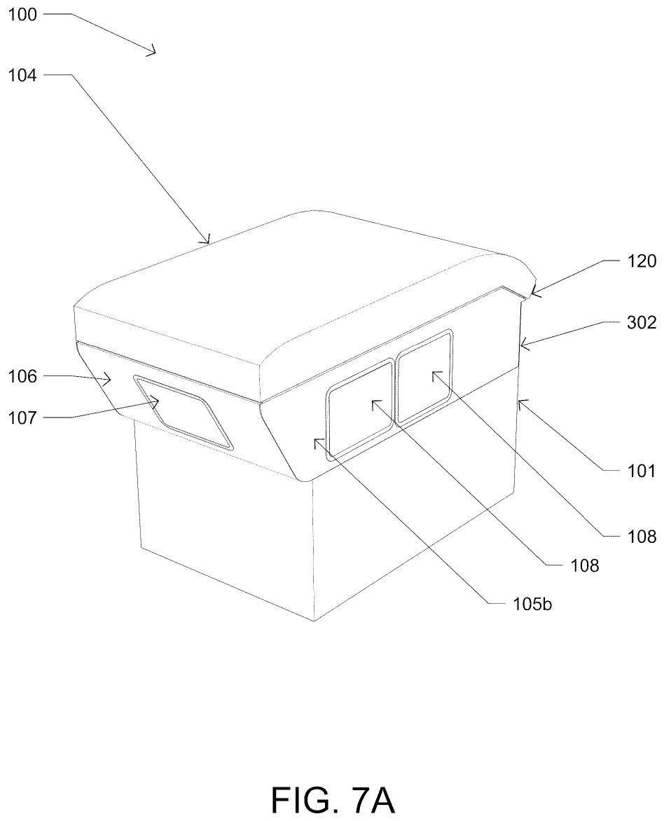

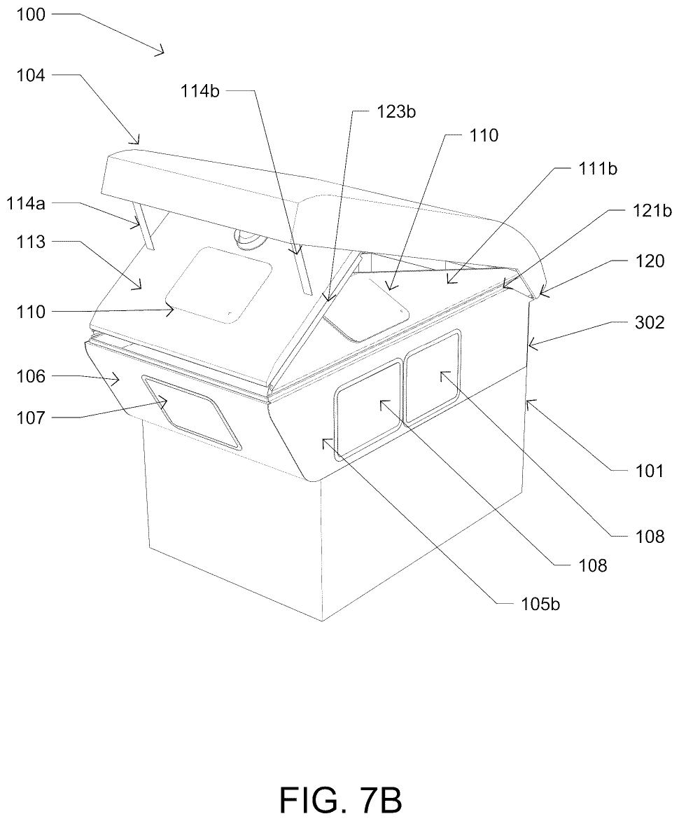

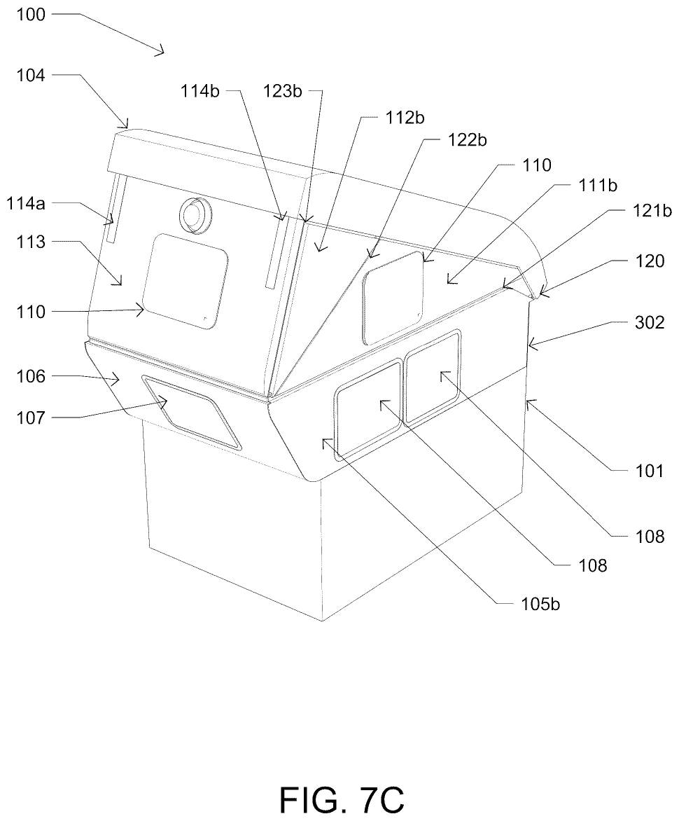

In the depicted embodiment, the roof 104 is attached to the base assembly of the system 100 via hinged line 120 at the front of the roof 104 and the front of the cabover 202. In other embodiments, the roof 104 may be attached to the base assembly of the system 100 via hinged line 120 at the front of the roof 104 and the top of the front wall 302 if the cabover 202 is omitted, FIGS. 7A-7C.

In the depicted embodiment, the roof 104 is additionally attached to the rear panel 113 via hinged stays 114a and 114b. The rear panel 113 is additionally attached to the upper side panels 112a and 112b via hinged lines 123a and 123b. The upper side panels 112a and 112b are additionally attached to the lower side panels 111a and 111b via hinged lines 122a and 122b. The lower side panels 111a and 111b are additionally attached to the side walls 105a and 105b of the base assembly via hinged lines 121a and 121b.

In the depicted embodiment, the two lower side panels 111a and 111b and rear panel 113 contain windows 110, which can be opened or closed to allow light and air into the interior of the system 100. The size and number of windows 110 can be omitted or vary in other embodiments and may be additionally placed in the upper side panels 112a and 112b. Other elements can also be included in other embodiments, such as fans, vents, hatches, doors, or similar. This list is not exhaustive and is only meant to show examples of other elements that can be included. When the system 100 is in a closed position the elements in the expandable assembly, such as windows 110, are protected from the outside.

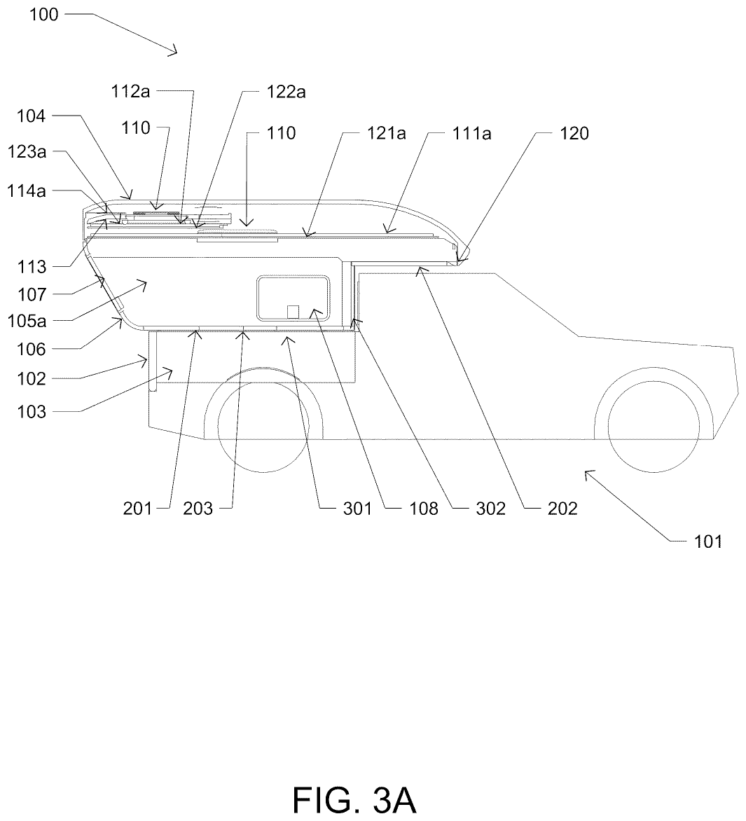

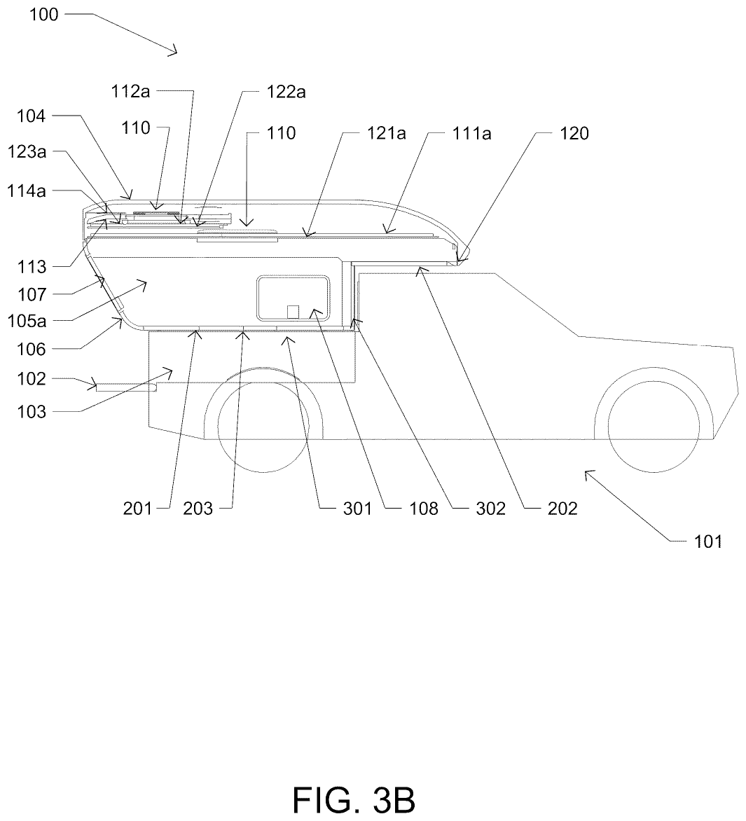

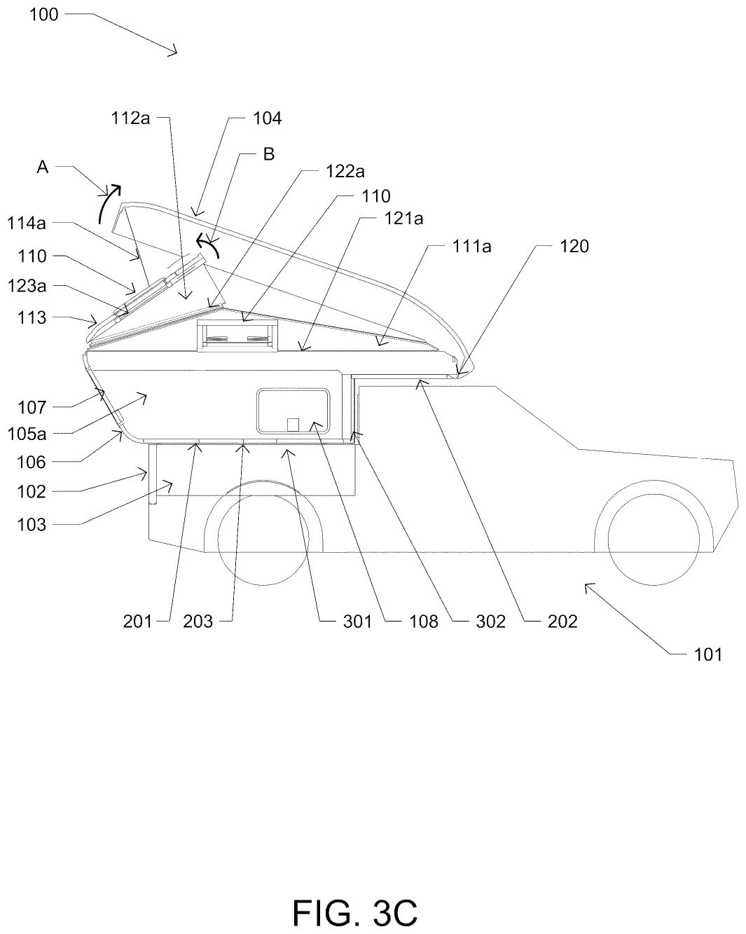

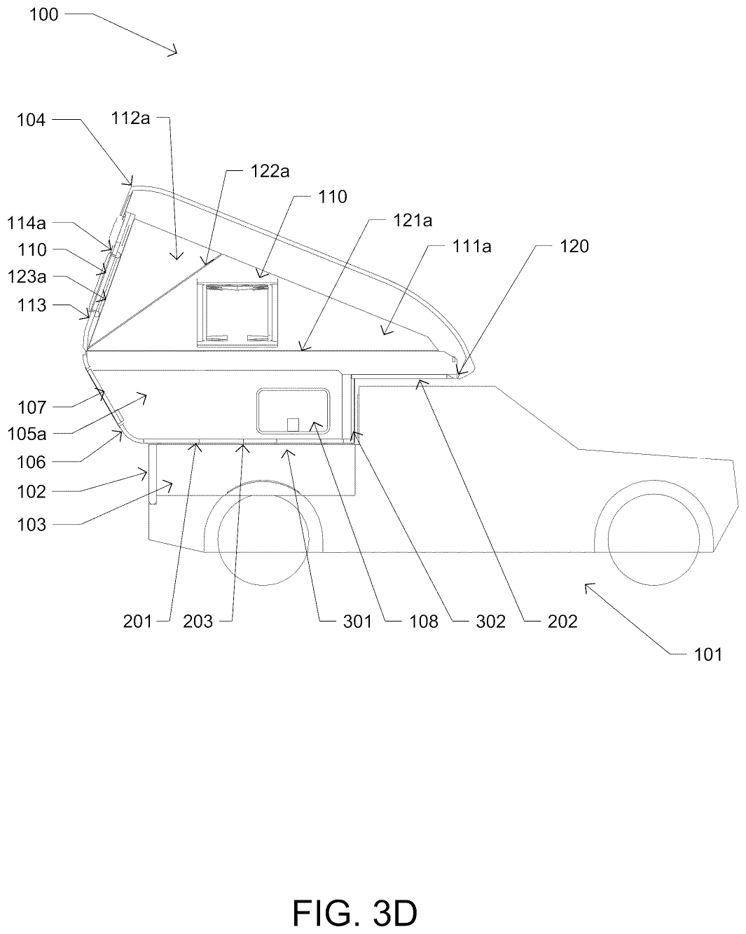

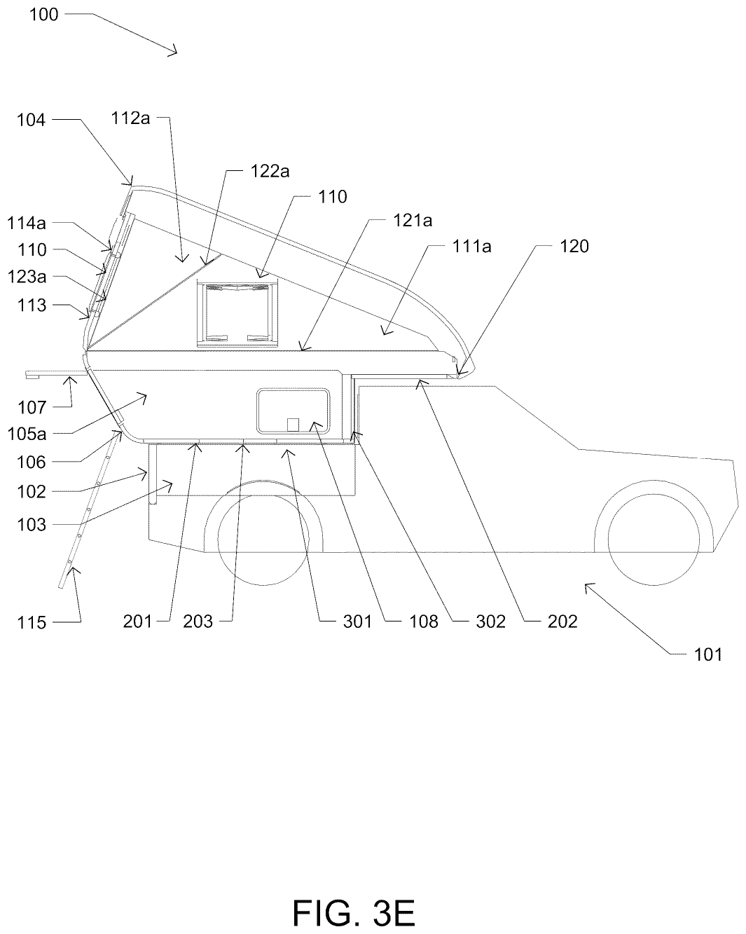

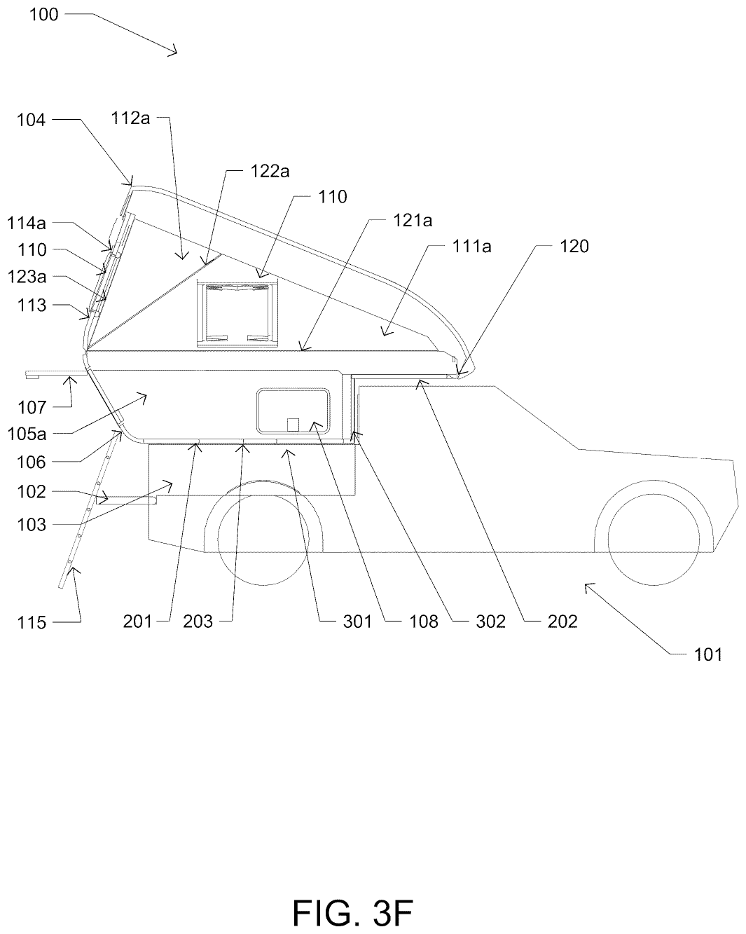

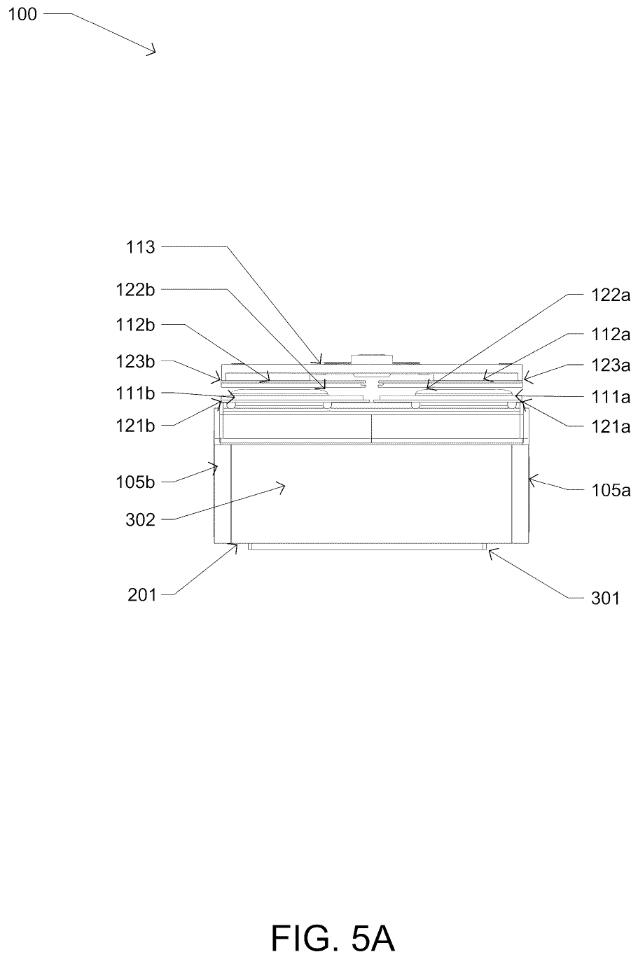

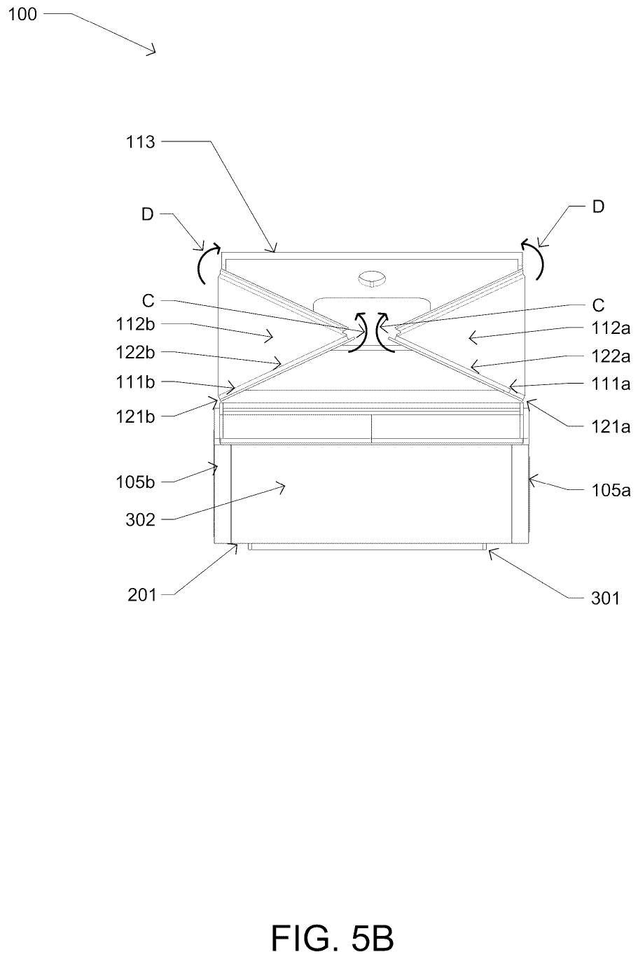

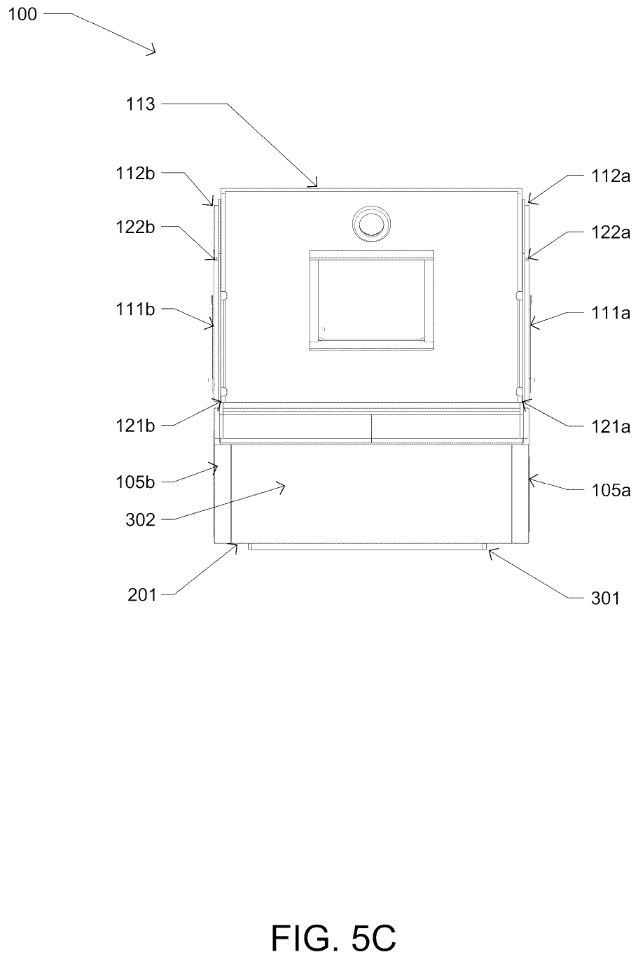

In the depicted embodiment, the system 100 is opened in the following manner: The roof 104 is released to allow the expandable assembly of the system 100 to pivot and move in an upward direction along hinged line 120, as depicted in FIG. 3C Motion A. The movement of the roof 104 causes the rear panel 113 to articulate upwards and outwards through the use of hinged stays 114a and 114b attached to the roof 104 and rear panel 113, as depicted in FIG. 3C Motion B. The movement of the rear panel 113 causes the upper side panels 112a and 112b to articulate upwards and outwards along hinged lines 123a and 123b, as depicted in FIG. 5B Motion D. The movement of the upper side panels 112a and 112b cause the lower side panels 111a and 111b to pivot upwards and outwards along hinged lines 122a and 122b, as depicted in FIG. 5B Motion C. The side panels when in an upright position are then secured to the roof 104.

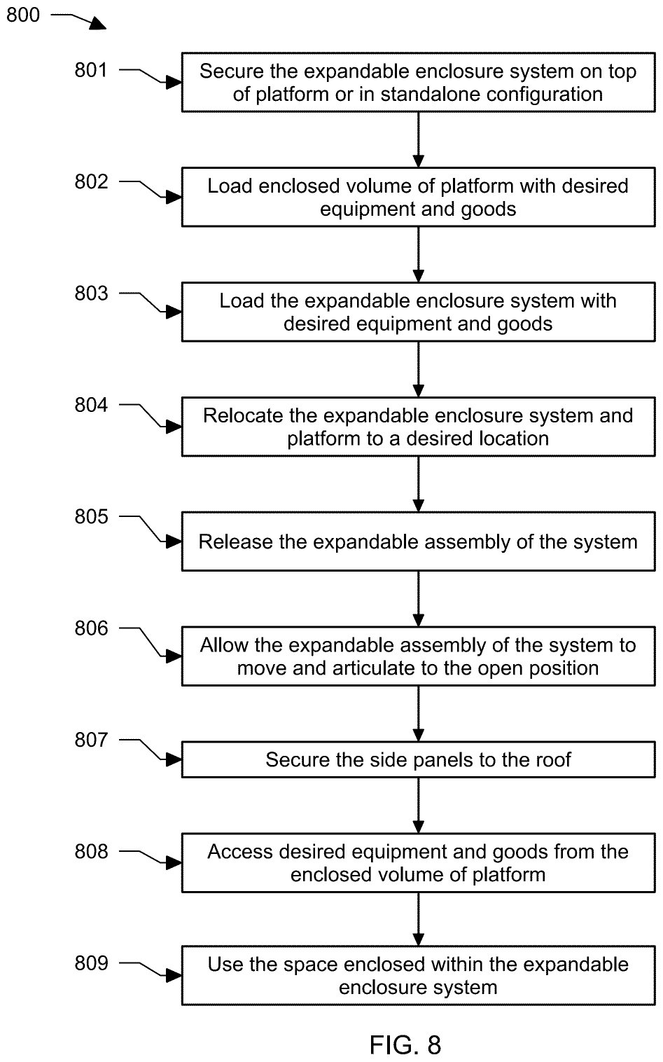

The preferred method and use of the expandable enclosure system 100 is described in FIG. 8. Method 800 comprises of coupling the expandable enclosure system on top of the platform or in standalone configuration 801, loading the enclosed volume of platform with desired equipment and goods 802, loading the expandable enclosure system with desired equipment and goods 803, relocating the expandable enclosure system and platform to a desired location 804, releasing the expandable assembly of system 805, allowing the expandable assembly of the system to move and articulate to the open position 806, securing the side panels to the roof 807, accessing desired equipment and goods from the enclosed volume of platform 808, and using the space enclosed within the expandable enclosure system 809.

The particular embodiments described above are meant to be illustrative of the some of the methods and uses of the expandable enclosure system 100. Other methods, uses, modifications, and variations may be made but are considered within the scope and spirit of the invention.

1. An expandable enclosure system comprising:
a base assembly, comprising:
at least two side walls;
at least one front wall;
at least one rear wall; and
a floor; and
an expandable assembly, comprising:
at least two lower panels hingedly connected to said side walls;
at least two upper side panels hingedly connected to said lower panels and a rear panel;
said rear panel hingedly connected to said upper side panels and stays;
at least two said stays hingedly connected to said rear panel and a roof; and
said roof hingedly connected to the said stays and said front wall;
wherein said roof is released to pivot and move in an upward direction;
wherein during opening said lower panel pivots upwards and outwards, said upper panels articulate upwards and outwards, said rear panel articulates upwards and outwards, and said stays rotate;
wherein said lower panel is secured to said roof; and
wherein said base assembly, said roof, said lower panels in an open position enclose a space.

2. The expandable enclosure system of claim 1,
wherein said expandable assembly in a closed position protects and secures windows, fans, vents, doors, or similar located in said panels.

3. The expandable enclosure system of claim 1,
wherein said expandable enclosure system in a closed position allows access to the interior volume through hatches, door, windows, or similar.

4. The expandable enclosure system of claim 1,
wherein said base assembly coupled to the top of a truck bed or similar encloses the volume of the truck bed;
wherein desired equipment and goods stored in truck bed or similar are secure and protected from exterior elements and environment.

5. The expandable enclosure system of claim 4,
wherein access to the truck bed is gained through hatches and openings in said floor.
